(19) United States
(12) Patent Application Publication
(10) Pub. No.: US 2006/0192841 A1
(43) Pub. Date: Aug. 31, 2006

(54) Sublimation thermal transfer recording medium and method of the thermal transfer recording therewith

(76) Inventors: Junichiro Sugita, Tochigi (JP); Youchiro Shutara, Tochigi (JP); Morio Sekiguchi, Tochigi (JP); Tatsuya Hasegawa, Tochigi (JP)

Correspondence Address: BELL, BOYD & LLOYD, LLC, PO BOX 1135, CHICAGO, IL, 60690-1135, US

(21) Appl. No.: 10/564,810

(22) PCT Filed: Sep. 27, 2004
(86) PCT No.: PCT/JP04/14062

§ 371 Date: Jan. 16, 2006

(30) Foreign Application Priority Data
Sep. 29, 2003 (JP) 2003-337113

(51) Int. Cl. B41J 2/325

(52) U.S. Cl. 347/213

(57) ABSTRACT

A sublimation thermal transfer recording medium and a thermal transfer recording method that can remove background stain and the like, and can realize gradation printing with good accuracy and high correlation between the applied heat quantity and the coloring density are provided. The sublimation thermal transfer recording medium includes a base sheet having formed on one surface thereof a number of thermal transfer dye layers having different hues in planar sequence one another. The thermal transfer dye layers contain a phenoxy resin as a main component of a binder resin, and contain a block copolymer silicone resin. The silicone resin preferably includes an amount of Si that ranges from 5% to 30% by weight, and a mixing ratio of a resin material and the silicone resin is preferably from 99:1 to 70:30.

### TECHNICAL FIELD

The present invention relates to a sublimation thermal transfer recording medium used as an ink ribbon for a dye-sublimation thermal transfer printer and the like, and more particularly, to an improvement in resin composition of a thermal transfer dye layer. The present invention also relates to a thermal transfer recording method using the sublimation thermal transfer recording medium.

### BACKGROUND ART

With a thermal transfer recording system using sublimation dye, a large number of color dots are transferred onto a transfer medium upon application of heat for an extremely short period, thereby reproducing a full-color image according to an original copy in using the color dots of multiple colors.

In the above described thermal transfer recording system, such a thermal transfer recording medium is used as an ink ribbon that has a base film such as a polyester film, having one surface thereof formed with a thermal transfer dye layer containing a thermal transfer dye (a sublimation dye), and the thermal transfer layers are superimposed on a photographic paper to be heated according to image information with a thermal head or the like, from a rear surface of the thermal transfer recording medium so that the sublimation dye in the thermal transfer dye layers is transferred to the photographic paper, thereby forming an desired dye image. In the case of formation of full-color images, the thermal transfer dye layers of three colors, yellow, magenta, and cyan, which are formed on one surface of the thermal transfer recording medium in planar sequence one another, are sequentially superimposed on the photographic paper to perform a thermal transfer operation. It is also practiced that a thermal transfer day layers of block color is transferred in addition to those of three colors to form a black image with higher density.

It is important in the thermal transfer recording medium of this type that a printed material colors in a high density as well as that a receiving material (e.g., the photographic paper or the like) is not defective in fusion bounding. From this viewpoint, a polyvinyl resin such as polyvinyl chloride, or a cellulose resin has been used as a binder resin of the thermal transfer dye layer on the thermal transfer recording medium.

For prevention of fusion bonding, it has been also proposed to add to the thermal transfer dye layer a silicone graft polymer obtained by modifying an acrylic, polyester, styrene or urethane polymer with silicone, a silicone oil, a phosphate ester, a fluorine surface active agent, or the like in a small amount (see, e.g., Patent Literature 1)

Patent Literature: Japanese Patent Laid-Open No. H09-234963)

### DISCLOSURE OF THE INVENTION

In the meanwhile, it is demanded that an image with a continuous density from low tone to high tone can be printed and that thermal transfer dye layer of the thermal transfer recording medium exhibits high correlation between applied heat quantity and coloring density to realize printing with highly accurate gradation.

In the thermal transfer dye layer of the thermal transfer recording medium, a resin having a molecular weight of 100,000 or more and a high glass transition point Tg (approximately from seventy degrees Celsius to ninety degrees Celsius) is generally used as a binder resin to prevent background stain from occurring due to residual heat of the thermal head.

In the case of the binder resin having a large molecular weight, however, it is difficult to produce the thermal transfer recording medium since an ink for forming the thermal transfer dye layer undesirably has a high viscosity at a time of preparation. Furthermore, the binder resin having a large molecular weight is inert in thermal behavior due to the high glass transition point Tg, thereby providing a low maximum printing density to cause a problem that the printing density is not enough to meet a demand especially for high speed printing. The coloring density has a tendency to further deteriorate due to hardness of a plastic card in the case where a letter (or an image) is directly printed on a surface of the plastic card made of, for example, soft vinyl chloride (containing approximately fifty percent of a plasticizer for vinyl chloride), on the condition of using the thermal transfer recording medium having a thermal transfer dye layer using a binder resin having a large molecular weight.

To solve the problems, it is considered that the glass transition point Tg and the molecular weight of the binder resin used in the thermal transfer dye later are set to be low, but in this case, while the total transferability is improved for sure, another problems arise that the background stain occurs on an unprinted area and that high density coloration quickly occurs before the heat quantity is sufficiently increased. It is therefore difficult to solve the background stain to realize printing with highly accurate gradation owing to high correlation between the applied heat quantity and the coloring density, only by setting the molecular weight and the glass transition point Tg of the binder resin of the thermal transfer dye layer.

On the other hand, it has been attempted that properties of the thermal transfer dye layer of the sublimation transfer recording medium are improved by adding a silicone material to the thermal transfer dye layer, so as to realize sharp printed images. The silicone chains are bled out to a surface with the lapse of time in the case where the silicone material is added to the thermal transfer dye layer, and thus such an effect can be obtained that the fusion bonding to the receiving material is prevented. At this moment, the art disclosed in Patent Literature 1 teaches that the sharp images can be formed by using a silicone-modified polymer.

However, the silicone-modified polymer used in the invention disclosed in Patent Literature 1 is a graft polymer having such a structure that silicone chains are introduced to the main chain (e.g., an acrylic chain) in a branched form. Therefore, the silicone chains as side chains are bled out to exhibit the mold releasing effect, but the main chain remains to stay in the binder to exhibit substantially no barrier effect to the dye. As a result, the background stain undesirably occurs.

It is considered that addition of the mold releasing agent, such as the aforementioned silicone-modified polymer, in a large amount may lower the coloration to suppress the background stain and the like in a certain extent, but in the case where an ordinary mold releasing agent or a silicone-modified polymer such as disclosed in Patent Literature 1 is added in such an amount as causing the aforementioned effect, other problem newly arises, such as separation of the dye and repelling thereof upon coating.

The present invention has been proposed in consideration of those conventional backgrounds and aims to provide a sublimation thermal transfer recording medium and a thermal transfer recording method capable of solving the background stain and the like and realizing printing with highly accurate gradation owing to high correlation between the applied heat quantity and the coloring density. The present invention furthermore aims to provide a sublimation thermal transfer recording medium causing no problems such as separation of the dye and repelling thereof upon coating.

To this end, the inventors have examined variously over a long period of time. As a result, the inventors have discovered that both resolution of the background stain and improvement in maximum printing density can be simultaneously realized, and gradation printing with good accuracy and high correlation between the applied heat quantity and the coloring density can be attained, by using both a phenoxy resin as a main component of the binder resin and a block copolymer silicone resin having a silicone chain introduced into the main chain.

The present invention has been accomplished based on the aforementioned knowledge and characterized in the sublimation thermal transfer recording medium that has a base sheet having one surface formed with a plurality of thermal transfer dye layers having different hues in planar sequence one another, in which the thermal transfer dye layers include a phenoxy resin as a main component of a binder resin and contain a block copolymer silicone resin.

In the present invention, a phenoxy resin is used as a main component of a binder resin of the thermal transfer dye layer, so that good thermal behavior is obtained to provide high correlation between the applied heat quantity and the coloring density and a high maximum printing density. A phenoxy resin has a merit of being easy to handle in manufacturing.

The block copolymer silicone resin provides high barrier effect to the dye since a main chain also migrates to the vicinity of the surface at a time when the silicone chain is bled out. Therefore, the proportion of the dye on the surface of the thermal transfer dye layer is lowered, and thus coloration does not readily occur after the residual heat only, thereby eliminating the background stain.

Furthermore, since the block copolymer silicone resin does not contain a silicone terminal group, which impairs compatibility and solubility with respect to the binder resin (the phenoxy resin) and the like, a formation of the thermal transfer dye layer can be uniformed, thereby not only suppressing diffusion of the dye, but also effectively eliminating the problems associated with separation of the dye and repelling thereof upon coating.

Yet, according to this invention, a thermal transfer recording method comprising the steps of bringing a receiving material in contact with a sublimation thermal transfer recording medium, applying heat from a back surface of the sublimation thermal transfer recording medium, and effecting printing on the receiving material is characterized in using the sublimation thermal transfer recording medium formed with a thermal transfer dye layer containing a phenoxy resin as a main binder resin and containing a block copolymer silicone resin and in printing directly a surface of a soft vinyl chloride card as the receiving material.

As described above, use of the sublimation thermal transfer recording medium according to this invention enables high density printing and eliminates the problem of background stain. Therefore, even when the receiving material is a soft vinyl chloride card, such printing can be realized, as having sufficient coloring density and accurate gradation owing to high correlation between the applied heat quantity and the coloring density.

According to this invention, the background stain and the like can be solved and printing with accurate gradation owing to high correlation between the applied heat quantity and the coloring density can be realized. Furthermore, such problems can be effectively eliminated upon formation of the thermal transfer dye layer, as separation of the dye and repealing thereof upon coating the thermal transfer dye layer.

### BRIEF DESCRIPTION OF THE DRAWINGS

FIG. 1 is a schematic perspective view illustrating an essential structure of a sublimation thermal transfer recording medium; and

FIG. 2 is a graph showing a gamma curve of each Embodiments and Comparative Examples.

### BEST MODE FOR CARRYING OUT THE INVENTION

Hereinafter, a sublimation thermal transfer recording medium and a thermal transfer recording method will be described in detail with reference to the figures.

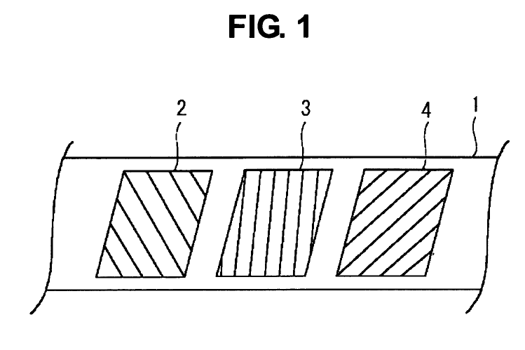

The sublimation thermal transfer recording medium has a base sheet having one surface thereof a plurality of thermal transfer dye layers having different hues are formed in planar sequence one another, and as shown in FIG. 1, a yellow thermal transfer dye layer 2, a magenta thermal transfer dye layer 3, and a cyan thermal transfer dye layer 4 are formed in planar sequence one another on one surface of a basic sheet 1, for example.

The sublimation thermal transfer recording medium thus structured may further have, on regions among the thermal transfer dye layers 2, 3, 4, a transparent transfer layer to be transferred to the receiving material, for preventing a dye having been already transferred to the receiving material from be retransferred onto the sublimation thermal transfer recording medium and for receiving a dye to be transferred next. Furthermore, the base sheet 1 of the sublimation thermal transfer recording medium may have, depending on necessity, a sensor mark or the like for detecting a position of the sublimation thermal transfer recording medium. The thermal transfer dye layers are not limited to the three colors as described above and may be formed upon addition of a black thermal transfer dye layer, for example. Alternatively, an image protecting layer may be formed, which is to be transferred on a completed image after forming image with the thermal transfer dye layers 2, 3, 4.

In the sublimation thermal transfer recording medium of this invention, sublimation dyes of yellow, magenta, and cyan colors are generally used in the thermal transfer dye layers 2, 3, 4, respectively, as described above but various kinds of sublimation dyes heretofore known can be used as a dye contained in the thermal transfer dye layers. Examples of the yellow dye include an azo dye, a disazo dye, a methane dye, a styryl dye, pyridone azo dye and the like, and any mixture thereof. Examples of the magenta dye include an azo dye, an anthraquinone dye, a syryl dye, a heterocyclic azo dye, and the like, and any mixture thereof. Examples of the cyan dye include an anthraquinone dye, a naphthoquinone dye, a heterocyclic azo dye, an indoaniline dye, and the like, and any mixture thereof. In the case where the black thermal transfer dye is provided, a dye heretofore known can be used as the black dye as well.

The thermal transfer dye layers 2, 3, 4, each is constituted from at least one of the aforementioned sublimation dye and a binder resin, while a phenoxy resin is used as a main component of the binder resin.

In the sublimation thermal transfer recording medium of this invention, the thermal transfer dye layers 2, 3, 4 contain a block copolymer silicone resin in addition to the aforementioned main component of the binder resin. Examples of the block copolymer silicone resin include a polysimethylsiloxane block copolymer or the like, and in particular, an acrylic silicone block copolymer (a block type acrylic modified silicone resin) is preferred. The polydimethylsiloxane block copolymer can be produced, for example, by copolymerizing a vinyl monomer using an azo group-containing polydimethylsiloxameamide as an initiator.

The polydimethylsiloxane block copolymer is disclosed in detail in Japanese Patent Laid Open No. 10-297123, and those disclosed Japanese Patent Laid Open No. 10-297123 can be used in this invention.

In general, the addition of a large amount of a mold releasing agent used for preventing adhesion to a receiving material causes somewhat deterioration in coloration. It is considered that this is because the silicone component of the mold releasing agent thus added is deposited on the surface of the thermal transfer recording medium with the lapse of time to barrier transfer of a dye. The critical surface tension of the thermal transfer recording medium in this state generally has a small value. However, in the case where an ordinary mold releasing agent is added enough to have an effect such as above, other problems arise, such as separation of the dye and repelling thereof upon coating. In the case of using a graft type silicone-modified polymer, unreacted groups present in the graft chains cause repelling and inhibition of dissolution, thereby providing a deteriorated coated form. In a microscopic view, the use of the graft silicone-modified polymer results in deteriorated compatibility with the main component of the binder and with the dye, so as to provide a small effect of suppressing excessive transfer of the dye.

In the case of using the block copolymer silicone resin, on the other hand, there is no such a silicone terminal group as impairing compatibility and dissolution, whereby the thermal transfer dye layer can be formed uniformly in comparison to a graft type silicone-modified polymer having a molecular weight and a glass transition point Tg substantially equivalent thereto, so as to provide a large effect of suppressing diffusion of the dye to the receiving material. Furthermore, the critical surface tension on the surface of the thermal transfer recording medium is significantly decreased to improve the effect as a mold releasing agent.

In the aforementioned block copolymer silicone resin, the amount of Si is preferably from 5% to 30% by weight. In the case where the Si amount is too small, the intended effect cannot be produced, whereas in the case where it is too large, there is such a possibility that problems can arise in compatibility and solubility. Furthermore, the mixing ratio of the main component of the binder resin and the block copolymer silicone resin is preferably in a range of from 99:1 to 70:30. In the case where the proportion of the silicone resin is lower than the above range, the intended effect cannot be produced, whereas in the case where it is too large in excess of the above range, there is such a possibility that problems arise in compatibility and solubility.

The thermal transfer dye layers 2, 3, 4 can be formed by a method heretofore known, and the sublimation dye, the binder resin, and the block copolymer silicone resin, for example, are dissolved or dispersed in a solvent to form a coating composition, which is then coated on one surface of the base sheet, followed by drying, to produce the thermal transfer dye layer. The thickness of the thermal transfer dye layers 2, 3, 4 are not particularly limited but is preferable from, e.g., 0.2 μm to 5 μm.

Various base materials heretofore known can be used as the basic sheet 1. Examples thereof include a polyester film, a polystyrene film, a polypropylene film, a polysulfone film, a polycarbonate film, a polyimide film, an aramid film, and the like. The thickness of the basic sheet 1 generally ranges from 1 μm to 30 μm, and preferably from 2 μm to 10 μm. The surface of the basic sheet 1, on which the thermal transfer dye layer is not formed, may be subjected to a heat resistant treatment or the like for preventing fusion bonding to a heating method used upon thermal transfer, such as a thermal head or the like.

The thermal transfer recording using the sublimation thermal transfer recording medium according to the invention can be carried out by using an ordinary sublimation printer or the like in an ordinary method. That is, a receiving material is brought in contact with the thermal transfer dye layer of the sublimation thermal transfer recording medium, and heat is applied to the back surface of the sublimation thermal transfer recording medium with a thermal head or the like to effect printing on the receiving material.

In this regard, the receiving material used herein can be an arbitrary receiving material, and by using the sublimation thermal transfer recording medium of this invention, printing can be effected directly on a hard surface of a soft vinyl chloride card. There is such a tendency that the coloring density of the surface of the soft vinyl chloride card is lowered due to the hardness thereof, but the use of the sublimation thermal transfer recording medium of the invention enables printing with sufficient coloring density and accurate gradation owing to high correlation between the applied heat quantity and the coloring density.

In the meanwhile, in the case where the surface of the soft vinyl chloride card is directly printed, a thin layer of the block copolymer silicone resin may be formed on one or both of the surface of the thermal transfer dye layer and the surface of the soft vinyl chloride card. In this case, it is also possible to omit addition of the block copolymer silicone resin to the thermal transfer dye layer.

### EMBODIMENT

Specific Embodiments of the present invention will be described based on experimental results.

### Embodiment 1, Comparative Examples 1, 2

A heat resistant layer was formed on a back surface of a polyethylene terephthalate film having a thickness of 6 μm, whereas an adhesive undercoating layer was formed on a front surface thereof, and a thermal transfer dye layer of cyan color was formed by coating on the undercoating layer to produce a sublimation thermal transfer recording medium (sublimation thermal transfer ribbon). The cyan thermal transfer dye layer was formed by coating with a coil bar a coating composition containing a resin and a mold releasing agent shown in Table 1 below to provide a dry thickness of 1.0 μm. A dye used in the coating composition was Sumiplast Blue OA, a trade name, produced by Sumitomo Chemical Co., Ltd., and a solvent used therein was methyl ethyl ketone, cyclohexanone, and N-methylpyrrolidone.

Kinds of the binder resin and the mold releasing agent referred in Table 1 were as follows.

PKHH: a phenoxy resin, PKHH, a trade name, produced by Union Carbide excessive in low energy regions to deteriorate reproduction of complexion in Comparative Example 1 using the graft type mold releasing agent. Deterioration is observed in reproduction of complexion and the possibility of background stain is high in Comparative Example 2 using the graft type mold releasing agent using the binder resin having a large molecular weight. Insufficiency of printing density and coloring density, which becomes problems in using the binder resin having a large molecular weight, can be resolved by using the mold releasing agent but deterioration in the images or the background stain becomes problems in using the graft type mold releasing agent because the dye transfer is excessive in low energy region, as described above. In the end, decent printing is attained at both high and low energies only where the block type mold releasing agent is combined with the phoenoxy resin.

Corporation;

PVB: Denka Butyral #6000C, a trade name, produced by Denki Kagaku Kogyo Co., Ltd. (Mw: about 150,000);

Block type mold releasing agent: Acrylic-silicone block copolymer varnish, SX082, a trade name, produced by Natoco Co., Ltd.; and

Graft type mold releasing agent: Acrylic-silicone graft copolymer vanish, US-380, a trade name, produced by Toagosei Co., Ltd.

TABLE 1

| | | Mold | | |
|---|---|---|---|---|
| | | Releasing | | |
| | Resin | agent | Ratio | P/B |
| Embodiment 1 | PKHH | Block type | 10% | 0.85 |
| Comparative | PKHH | Graft type | 10 | 0.85 |
| Example 1 | | | | |
| Comparative | PVB | Graft type | 10 | 0.7 |
| Example 2 | | | | |

Evaluation Method

The sublimation thermal transfer recording media of Embodiments and Comparative Examples were measured for gamma characteristics by subjecting to a printing test in a single cyan color with varying head energy.

Printer: Card Printer, P-310C, a trade name, produced by Eltron International, Inc.

Receiving material: Soft vinyl chloride card

Printing density measuring device: Macbeth Reflection Densitometer TR924, a trade name, produced by Gretag Macbeth, Inc.

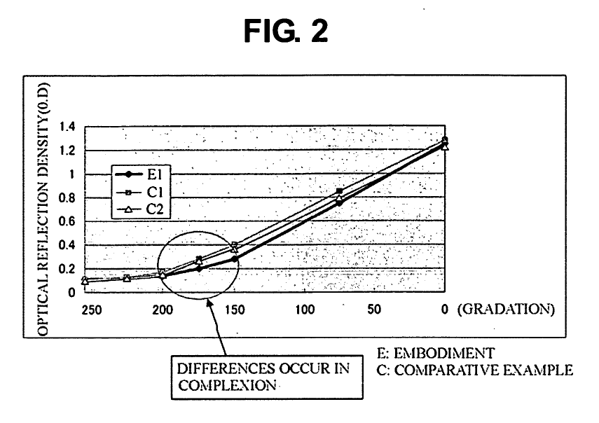

The obtained results are shown in Table 2 below and FIG. 2.

TABLE 2

| | 225 | 225 | 200 | 175 | 150 | 75 | 0 |
|---|---|---|---|---|---|---|---|
| Embodiment 1 | 0.11 | 0.12 | 0.14 | 0.2 | 0.28 | 0.75 | 1.25 |
| Comparative | 0.11 | 0.13 | 0.17 | 0.28 | 0.4 | 0.85 | 1.28 |
| Example 1 | | | | | | | |
| Comparative | 0.1 | 0.12 | 0.15 | 0.26 | 0.36 | 0.79 | 1.22 |
| Example 2 | | | | | | | |

Reproduction of complexion of human was evaluated in using the sublimation thermal transfer recording media of Embodiments and Comparative Examples, respectively. The results are shown in Table 3 below. The evaluation of complexion was made by additionally forming magenta and yellow thermal transfer dye layers in the same manner to print full color images, and by evaluating “A” to the case where complexion was reproduced without contradicting feeling, “B” to the case where slight color shift was observed, and “C” to the case where the dye was transferred in a too large amount in low energy regions to cause contradicting feeling as complexion.

TABLE 3

| | Complexion of human |
|---|---|
| Embodiment 1 | A |
| Comparative Example 1 | C |
| Comparative Example 2 | BC |

It is understood from the tables and figures that the good gradation printing is realized, and a sufficient printing density is obtained at high energy according to Embodiments of the present invention. On the other hand, the dye transfer is

1. A sublimation thermal transfer recording medium comprising a base sheet having formed on one surface thereof a plurality of thermal transfer dye layers having different hues in planar sequence one another,
the thermal transfer dye layers containing a phenoxy resin as a binder resin and containing a block copolymer silicone resin.

2. The sublimation thermal transfer recording medium according to claim 1, wherein the block copolymer silicone resin includes an amount of Si that ranges from 5% to 30% by weight.

3. The sublimation thermal transfer recording medium according to claim 1, wherein a mixing ratio of the binder resin to the block copolymer silicone resin ranges from 99:1 to 70:30.

4. A thermal transfer recording method comprising the steps of:
making a receiving material in contact with a sublimation thermal transfer recording medium; and
applying heat to a back surface of the sublimation thermal transfer recording medium to effect printing on the receiving material,
wherein the sublimation thermal transfer recording medium is formed with a thermal transfer dye layer containing a phenoxy resin as a binder resin and containing a block copolymer silicone resin, and
wherein the receiving material includes a soft vinyl chloride card such that printing is effected directly on a surface thereof.
